(19) United States
(12) Patent Application Publication
(10) Pub. No.: US 2004/0247740 A1
(43) Pub. Date: Dec. 9, 2004

(54) Mold clamping apparatus

(75) Inventors: Makoto Tsuji, Kanagawa (JP); Hiroshi Yokoyama, Kanagawa (JP); Shinya Itani, Kanagawa (JP)

Correspondence Address: PILLSBURY WINTHROP, LLP, P.O. BOX 10500, MCLEAN, VA, 22102, US

(73) Assignee: TOSHIBA KIKAI KABUSHIKI KAISHA, Tokyo (JP)

(21) Appl. No.: 10/835,277

(22) Filed: Apr. 30, 2004

(30) Foreign Application Priority Data
May 1, 2003 (JP) 2003-126438
May 6, 2003 (JP) 2003-128062

(51) Int. Cl. B29C 45/66

(52) U.S. Cl. 425/595

(57) ABSTRACT

A mold clamping apparatus able to shorten the cycle time required for mold opening and clamping operations and enabling easy pullout of tie bars, provided with a fixed die plate for holding a fixed die, a moveable die plate for holding a moveable die plate and provided movable in mold opening/closing directions, tie bars provided with linking parts at their free ends and supported by the moveable die plate, clamping cylinders provided at the moveable die plate and driving the moveable die plate relative to the tie bars, movement mechanisms for making the moveable die plate move in the mold opening/closing directions and opening and closing the dies, contacting members against which the free ends of the tie bars contact so as to position the tie bars at predetermined positions with respect to the fixed die plate, and half nuts for linking with linking parts of the tie bars positioned at the predetermined positions and linking the tie bars with the fixed die plate.

### BACKGROUND OF THE INVENTION

1. Field of the Invention

The present invention relates to a mold clamping apparatus used for a die cast machine, plastic injection molding machine, or other molding machine.

2. Description of the Related Art

In a die cast machine, plastic injection molding machine, or other molding machine, for example a moveable die or mold is clamped to a fixed die or mold to join them together and the molding material is injected into the cavity formed at that time to fill it. Note that hereinafter in this specification, the term “die” as used for die cast machines should be understood as including the term “mold” for molding machines.

As such a mold clamping apparatus for clamping dies, for example, there are known a toggle type mold clamping apparatus, direct pressure type mold clamping apparatus, composite mold clamping apparatus, etc. A composite mold clamping apparatus, as disclosed for example in Japanese Unexamined Patent Publication (Kokai) No. 10-52841, Japanese Unexamined Utility Model Publication (Kokai) No. 5-7419, and Japanese Unexamined Utility Model Publication (Kokai) No. 5-49330, is provided separately with an actuator for moving a moveable die plate with respect to a fixed die plate so as to open and close the dies and an actuator for clamping the dies.

As such a composite mold clamping apparatus, there is known one which connects sawtooth type grooves formed at free ends of tie bars by half nuts provided at a fixed die plate so as to link the fixed die plate and the moveable die plate through the tie bars. In this type of mold clamping apparatus, it is necessary to open and close the half nuts after positioning the moveable die plate at a predetermined position with respect to the fixed die plate. The demerit is therefore encountered of the cycle time for the series of die opening and closing and clamping operations becoming longer. In particular, in a mold clamping apparatus used for a die cast machine, to exchange dies, it is necessary to pull out the tie bars from the fixed die plate to prevent interference between the dies to be exchanged and the tie bars. The operation of pulling out the tie bars from the fixed die plate requires a special cylinder apparatus or other mechanism and therefore poses the problem of higher system costs.

### SUMMARY OF THE INVENTION

An object of the present invention is to provide a mold clamping apparatus enabling the cycle time required for die opening and closing and clamping operations to be shortened and enabling tie bars to be easily pulled out.

According to a first aspect of the present invention, there is provided a mold clamping apparatus for clamping a first die and a second die, comprising a fixed die plate for holding the first die and fixed to a base; a moveable die plate for holding the second die and provided on the base so as to be able to move relative to the fixed die plate so as to clamp or open the second die with respect to the first die; a pair of tie bars provided with linking parts at their free ends and supported by the top two ends of the moveable die plate; a pair of clamping cylinders provided at the top two ends of the moveable die plate and driving the moveable die plate with respect to the pair of tie bars; a pair of movement mechanisms engaged with the two bottom ends of the moveable die plate in the die opening/closing directions and making the moveable die plate move when opening and closing the pair of dies; a pair of contacting members for positioning the pair of tie bars at predetermined positions with respect to the fixed die plate by being contacted against by the free ends of the pair of tie bars; and linking means for linking the pair of linking parts of the pair of tie bars positioned at the predetermined positions and linking the tie bars releasably at the fixed die plate.

According to a second aspect of the present invention, there is provided a mold clamping apparatus comprising a mold clamping apparatus for clamping a first die and a second die, comprising a fixed die plate for holding the first die and fixed to a base; a moveable die plate for holding the second die and provided on the base so as to be able to move relative to the fixed die plate so as to clamp or open the second die with respect to the first die; a pair of tie bars provided with linking parts at their free ends and supported by the top two ends of the fixed die plate; a pair of clamping cylinders provided at the top two ends of the fixed die plate and driving the pair of tie bars with respect to the fixed die plate; a pair of movement mechanisms engaged with the two bottom ends of the moveable die plate in the die opening/closing directions and making the moveable die plate move when opening and closing the pair of dies; a pair of contacting members for positioning the pair of tie bars at predetermined positions with respect to the moveable die plate by being contacted against by the free ends of the pair of tie bars; and linking means for linking the pair of linking parts of the pair of tie bars positioned at the predetermined positions and linking the tie bars releasably at the moveable die plate.

### BRIEF DESCRIPTION OF THE DRAWINGS

These and other objects and features of the present invention will become clearer from the following description of the preferred embodiments given with reference to the attached drawings, wherein:

FIG. 1 is a view of the structure of a mold clamping apparatus according to a first embodiment of the present invention;

FIG. 2 is a cross-sectional view in the horizontal direction showing the structure of the mold clamping apparatus of FIG. 1;

FIG. 3 is an enlarged view of the inside of a circle A of FIG. 1;

FIGS. 4 to 8 are views of an example of the operation of the mold clamping apparatus of the first embodiment;

FIG. 9 is a view illustrating a withdraw of a tie-bar in the mold clamping apparatus of the first embodiment;

FIG. 10 is a view of the structure of a mold clamping apparatus according to a second embodiment of the present invention;

FIG. 11 is a cross-sectional view in the horizontal direction showing the structure of the mold clamping apparatus illustrated in FIG. 10;

FIGS. 12 to 16 are views for explaining the operation of the mold clamping apparatus of the second embodiment; and

FIG. 17 is a view for explaining a method of pulling out tie bars in a mold clamping apparatus of the second embodiment.

### DESCRIPTION OF THE PREFERRED EMBODIMENTS

Below, preferred embodiments of the present invention will be explained with reference to the attached drawings.

### First Embodiment

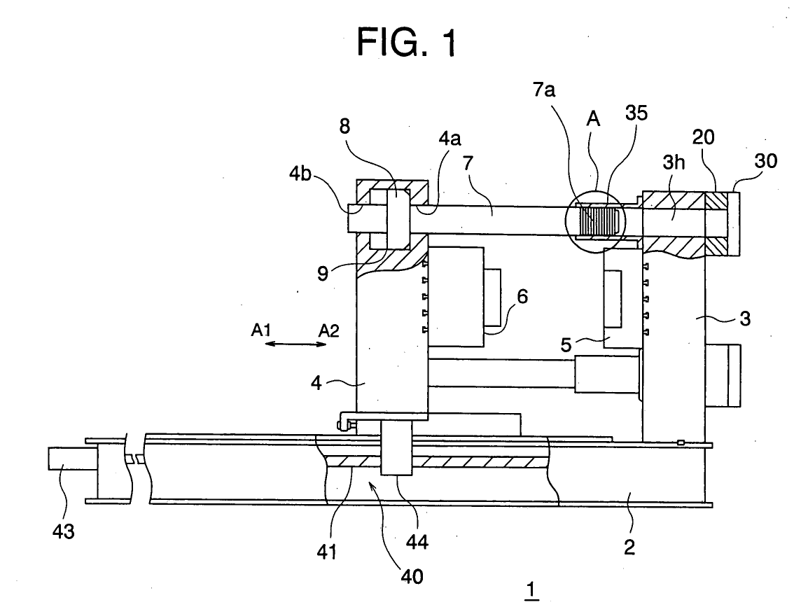

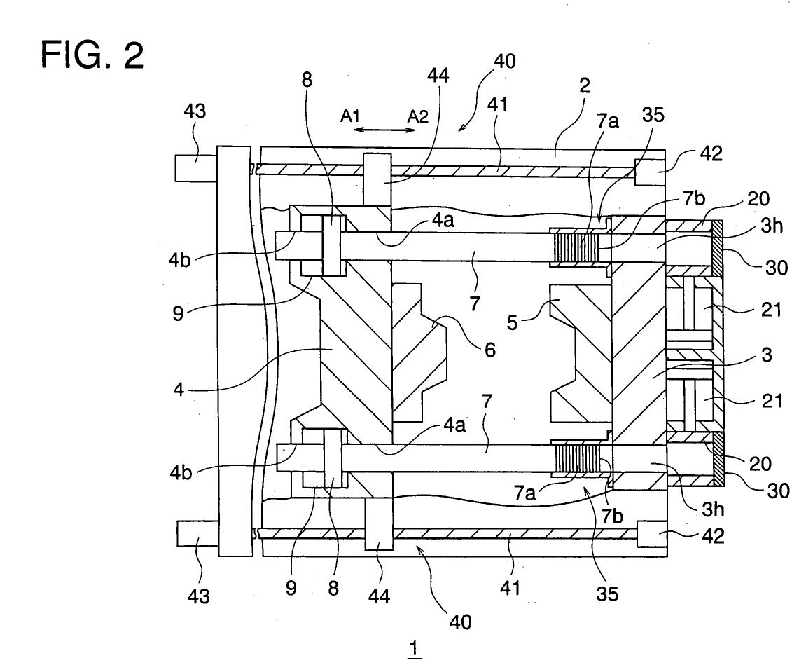

FIG. 1 is a view of the structure of a mold clamping apparatus according to a first embodiment of the present invention, while FIG. 2 is a cross-sectional view in the horizontal direction showing the structure of the mold clamping apparatus of FIG. 1. The mold clamping apparatus 1 of the present embodiment is for example used for a die cast machine.

As shown in FIG. 1 and FIG. 2, the mold clamping apparatus 1 has a base 21, a fixed die plate 3, a moveable die plate 4, a pair of tie bars 7, 7, a pair of clamping cylinders 9, 9, a pair of movement mechanisms 40, 40, a pair of half nuts 20, 20, a pair of contacting members 30, 30, and a pair of guide parts 35, 35. Note that the fixed die plate 3 is the fixed die plate of the present invention, the moveable die plate 4 is the moveable die plate of the present invention, the tie bars 7, 7 are the tie bars of the present invention, the clamping cylinders 9, 9 are the clamping cylinders of the present invention, the movement mechanisms 40, 40 are the movement mechanisms of the present invention, the half nuts 20, 20 are the linking means of the present invention, the contacting members 30, 30 are the contacting members of the present invention, and the guide parts 35, 35 are the guide means of the present invention.

The fixed die plate 3 is fixed at its bottom to the flat base 2. The fixed die plate 3 holds the fixed die 5 at its front side facing the moveable die plate 4. The two top ends of the fixed die plate 3 are formed with a pair of through holes 3h, 3h for insertion of the pair of tie bars 7, 7. The moveable die plate 4 holds the moveable die 6 at its front side (side facing the fixed die plate 3). This moveable die plate 4 is provided movable in the die opening direction A1 and the die closing direction A2 at the later explained movement mechanisms 40. When the moveable die 6 is moved toward the fixed die 5 and the pair of the fixed die 5 and the moveable die 6 are closed, a cavity is formed between the fixed die 5 and the moveable die 6. A not shown injection system is provided at the back surface of the fixed die plate 3. This injection system injects and fills a melt into the cavity formed between the fixed die 5 and the moveable die 6. Note that when the melt is injected and filled into the cavity, the fixed die 5 and the moveable die 6 are clamped so as to prevent the melt from leaking from the joined surfaces of the fixed die 5 and the moveable die 6.

The pair of tie bars 7, 7 are supported movably at the top of the moveable die plate 4 at first ends. The tie bars 7, 7 are supported horizontally along the die opening direction A1 and the die closing direction A2. The first ends of the tie bars 7, 7 are linked by pistons 8, 8. The two side parts of the pistons 8, 8 are fit into the pair of support holes 4a:4b, 4a:4b formed at the moveable die plate 4. The support holes 4a:4b, 4a:4b support the tie bars 7, 7 at the first ends. The other ends of the tie bars 7, 7, that is, the free ends, are formed with sawtooth shaped linking grooves 7a, 7a. Note that the linking grooves 7a, 7a are embodiments of the linking parts of the present invention.

The clamping cylinders 9, 9 are formed inside the moveable die plate 4. The moveable die plate 4 houses pistons 8, 8 in a movable manner. The cylinder chambers of the clamping cylinders 9, 9 are supplied with high pressure working fluid, whereby force acts between the moveable die plate 4 and tie bars 7, 7 and the tie bars 7, 7 and moveable die plate 4 are moved relative to each other. The moveable die plate 4 can move with respect to the tie bars 7, 7 within the movable range of the pistons 8, 8 linked with the tie bars 7, 7, that is, the range of the strokes of the clamping cylinders 9, 9.

The pair of movement mechanisms 40, 40 are housed inside the base 2. Each of the pair of movement mechanisms 40, 40 has a screw shaft 41, a support member 42, a servo motor 43, and a movable member 44. The support member 42 rotatably supports one end of the screw shaft 41. The other end of the screw shaft 41 is connected to the servo motor 43. The screw shaft 41 is screwed into the movable member 44. The pair of movable members 44 are fixed at the two sides of the moveable die plate 4.

In the movement mechanisms 40, 40, the servo motors 43, 43 are controlled in operation so that the screw shafts 41, 41 turn and rotations of the screw shafts 41, 41 are converted to linear motions of the movable members 44, 44. Due to this, the moveable die plate 4 at the two sides of which the pair of movable members 44 are fixed is driven in the die opening direction A1 or the die closing direction A2.

Half nuts 20, 20 are arranged at the backs of the pairs of through holes 3h, 3h of the fixed die plate 3. The half nuts 20, 20 are formed with not shown grooves engaging with the linking grooves 7a, 7a of the tie bars 7, 7. Each of the half nuts 20, 20 is opened and closed by a half nut opening/closing cylinder 21. When a half nut 20 is closed and engages with (is linked with) the linking groove 7a of the corresponding tie bar 7, the tie bar 7 and fixed die plate 3 are linked together. When the, half nut 20 is opened, the link between the tie bar 7 and fixed die plate 3 is released.

The contacting members 30, 30 position the tie bars 7, 7 at predetermined positions by being contacted against by the free ends 7b, 7b of the tie bars 7, 7. The predetermined positions are positions where the half nuts 20, 20 can link with the linking grooves 7a, 7a of the tie bars 7, 7. The tie bars 7, 7 are restricted in movement by striking the contacting members 30, 30. The contacting members 30, 30 are fixed to the back surface of the fixed die plate 3 by not shown connecting members.

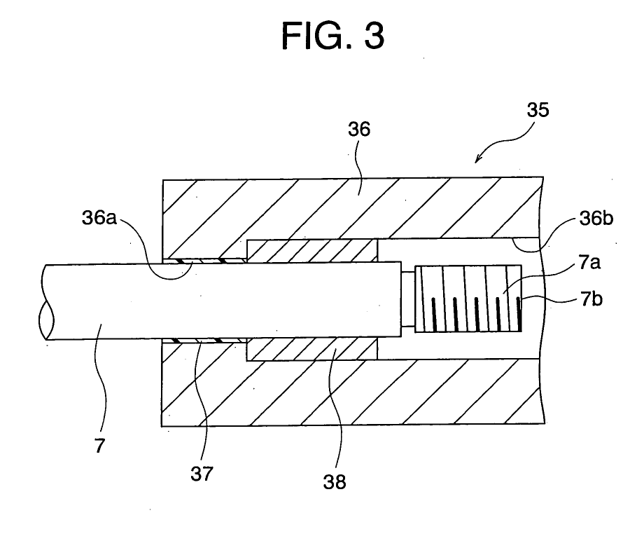

FIG. 3 is an enlarged view of the inside of the circle A of FIG. 1 and shows the structure of a guide part 35 in cross-section. The guide part 35 has a hollow cylindrically shaped guide member 36. The guide member 36 has a first through hole 36a at its front end and further has a second through hole 36b of a larger diameter than the first through hole 36a connected to the first through hole 36a. The guide member 36 is fixed concentrically with the through hole 3h at the front face of the fixed die plate 3. The inside circumference of the first through hole 36a is provided with a seal member 37, while the inside circumference of the second through hole 36b is provided with a bushing 38.

The shaft part of the tie bar 7 is fit through the inside circumference of the seal member 37. As the seal member 37, for example, a plastic one is used. The seal member 37 prevents release agent used at the dies at the time of casting or other foreign matter from entering the guide member 36. Due to this, deposition of foreign matter at the linking groove 7a of the tie bar 7 can be prevented and accordingly the linking between the linking groove 7a of the tie bar 7 and the half nut 20 becomes reliable.

The bushing 38 is for example formed by a plastic, metal, or other material. The outer circumference of the bushing 38 is fit in the second through hole 36b of the guide member 36. Further, the shaft part of the tie bar 7 is fit in the inside circumference of the bushing 38. The bushing 38 supports the tie bar 7 movably in the axial direction by engagement with the tie bar 7. Due to this, the tie bar 7 becomes resistant to flexing. Note that the length of the guide part 35 in the axial direction is the length required for the linking groove 7a of the tie bar 7 to fit inside the guide member 36 in the range of opening and closing of the fixed die and the moveable die 6. The outside diameter of the linking groove 7a of the tie bar 7 is smaller than the inside diameters of the seal member 37 and the bushing 38, so there is no spatial interface with the seal member 37 and the bushing 38.

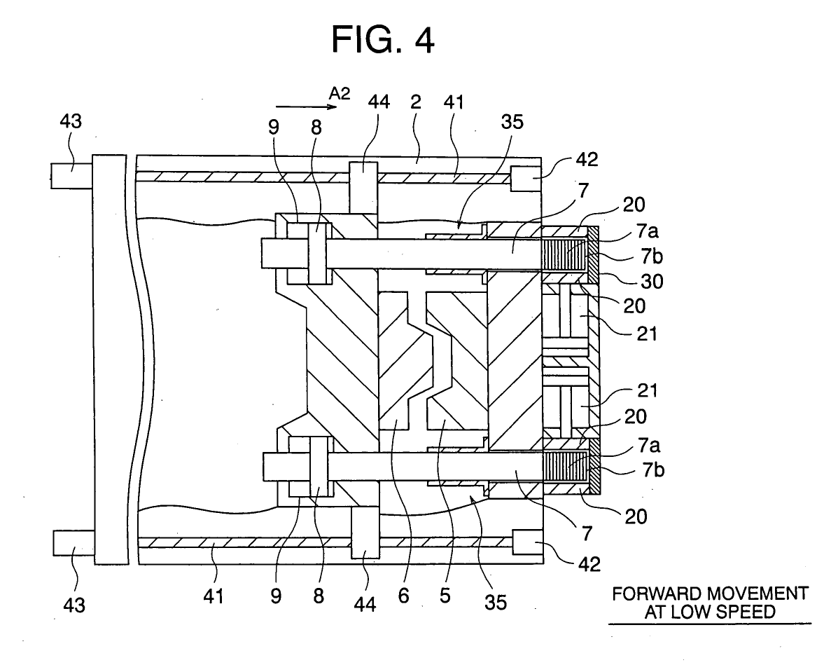

An example of the operation of the mold clamping apparatus of the above configuration will be explained next. The state of the mold clamping apparatus 1 shown in FIG. 1 and FIG. 2 is one where the moveable die plate 4 has moved to a predetermined opening position. In this state, the pistons 8, 8 are positioned at the die side in the cylinder chambers. From this state, the servo motors 43, 43 are driven to move the moveable die plate 4 in the die closing direction A2. The moveable die plate 4 is moved at a high speed from the viewpoint of shortening the cycle time. When the moveable die plate 4 moves in the closing direction A2, as shown in FIG. 4, the free ends 7b, 7b of the tie bars 7, 7 strike the contacting members 30, 30, whereby the tie bars 7, 7 stop. At this position, the linking grooves 7a, 7a of the tie bars 7, 7 can link with the half nuts 20, 20. Note that from the viewpoint of easing shock, it is preferable to reduce the operating speeds of the servo motors 43, 43 right before the free ends 7b, 7b of the tie bars 7, 7 strike the contacting members 7b, 7b.

In the state with the free ends 7b, 7b of the tie bars 7, 7 contacting against the contacting members 30, 30, the clamping cylinders 9, 9 are not supplied with high pressure working oil. Therefore, the pistons 8, 8 can move inside the cylinder chambers of the clamping cylinders 9, 9.

As shown in FIG. 4, when the free ends 7b, 7b of the tie bars 7, 7 contact against the contacting members 30, 30 and the tie bars 7, 7 are positioned, the half nut opening/closing cylinders 21, 21 are driven to close the half nuts 20, 20.

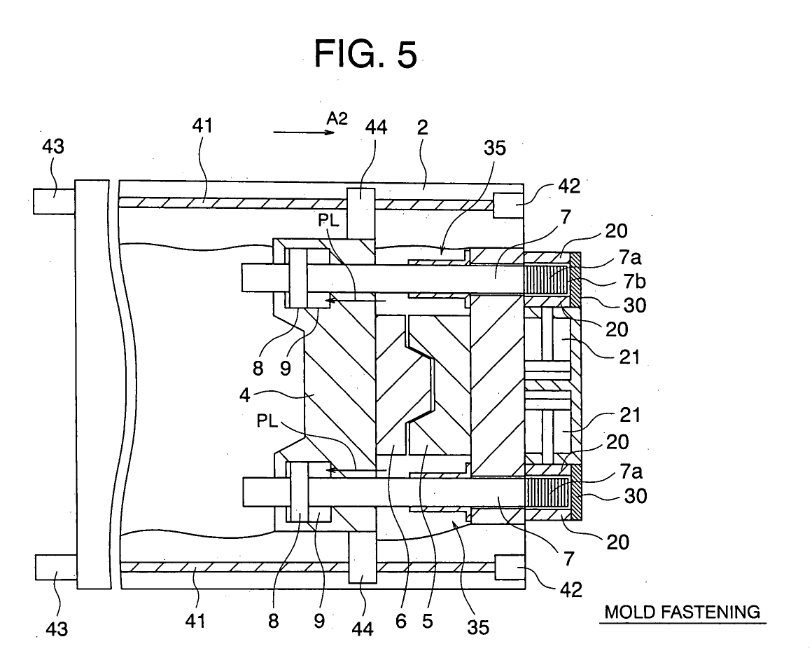

In parallel with the operation for closing the half nuts 20, 20, the moveable die plate 4 continues to be moved in the die closing direction A2 by the movement mechanisms 40, 40. The moveable die plate 4 moves to the predetermined closing position with respect to the tie bars 7, 7 and, as shown in FIG. 5, the moveable die 6 and the fixed die 5 finish being closed. That is, the moveable die plate 4 moves in the range of the strokes of the clamping cylinders 9, 9 and the dies are closed after the tie bars 7, 7 are positioned. The pistons 8, 8 move to the opposite side from the moveable die 6 in the cylinder chambers. Due to this, the linking operations of the half nuts 20, 20 and the linking grooves 7a, 7a of the tie bars 7, 7 are performed overlappingly during movement of the moveable die plate 4.

Next, as shown in FIG. 5, the moveable die plate 4 moves to a predetermined closing position, whereupon, as shown in FIG. 5, high pressure working oil PL is supplied to the cylinder chambers of the fixed die plate 3 sides of the clamping cylinders 9, 9 and the dies are clamped. Due to the supply of the high pressure working oil PL to the cylinder chambers, the pistons 8, 8 move further to the opposite side from the moveable die 6. Due to this, the tie bars 7, 7 extend and a clamping force commensurate with the amount of extension of the tie bars 7, 7 is generated. This clamping force can be controlled by adjusting the pressure of the working oil PL supplied to the cylinder chambers. For example, it is possible to control the clamping force linked with the injection operation of melt into the cavity formed by the fixed die 5 and moveable die 6. Due to this, it becomes possible to cast by the minimum clamping force while preventing melt from spraying out from the joined surfaces of the moveable die 6 and fixed die 5. By making the clamping force smaller, it is possible to prevent damage to the moveable die 6 and the fixed die 5 and extend the lifetime.

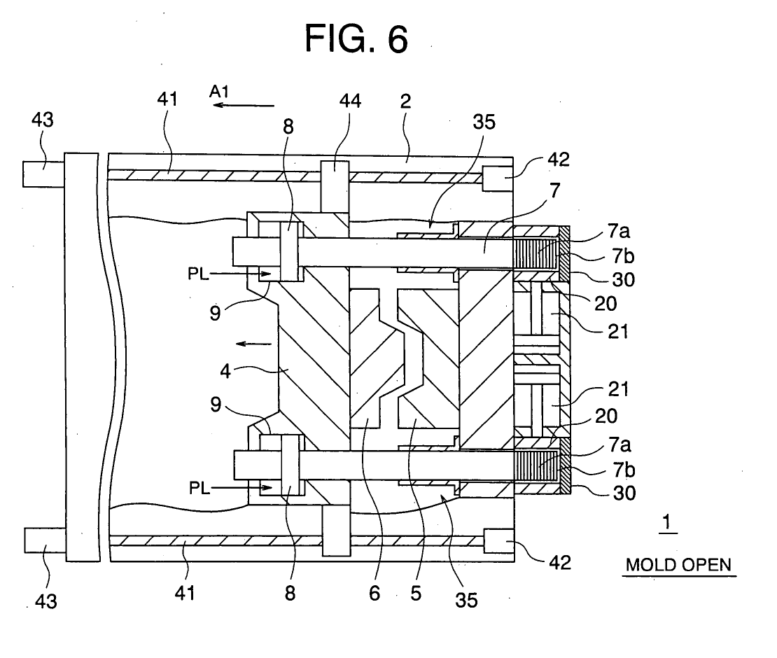

After the melt finishes being injected and filled into the cavity, as shown in FIG. 6, high pressure working oil PL is supplied to the cylinder chambers at the opposite side to the time of clamping of the clamping cylinders 9, 9. The clamping cylinders 9, 9 have predetermined strokes, so the moveable die plate 4 moves in the opening direction Al in the range of those strokes and the dies are unclamped. At this time, a force unclamping the dies acts on the tie bars 7, 7 in the axial direction. This unclamping force is however received by the contacting members 30, 30. The pistons 8, 8 move toward the die side in the cylinder chambers.

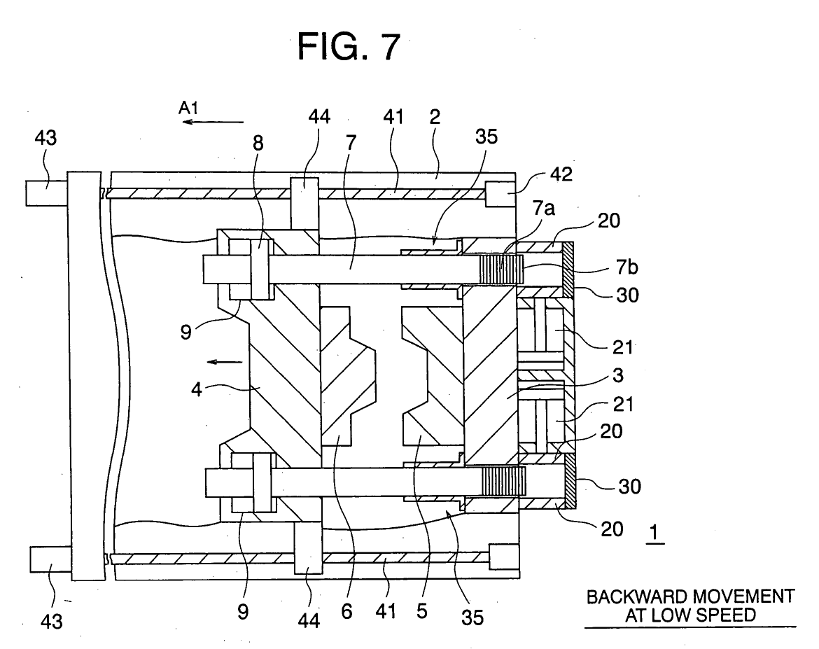

Overlapping with the unclamping action, the half nuts 20, 20 are released. Due to this, the link between the tie bars 7, 7 and the fixed die plate 3 is released. By performing the unclamping operation and the releasing operation of the half nuts 20, 20 overlappingly, the cycle time can be shortened. Next, the servo motors 43, 43 are driven and, as shown in FIG. 7, the moveable die plate 4 is retracted to a predetermined position at a low speed. The moveable die plate 4 is moved at a low speed because if the moveable die plate 4 were made to retract at a high speed rapidly right after opening the dies 5, 6, the casting product or the dies might be damaged or other problems might arise.

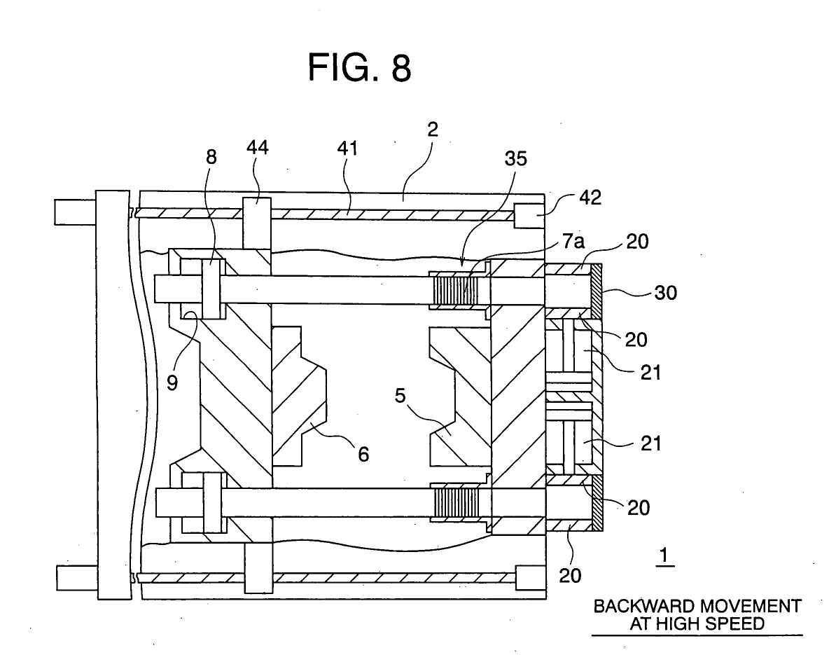

If the moveable die plate 4 is retracted to a predetermined position at a low speed, as shown in FIG. 8, the moveable die plate 4 is retracted at a high speed up to the opening position in the same way as in FIG. 1. With this operation, the series of clamping operations is ended.

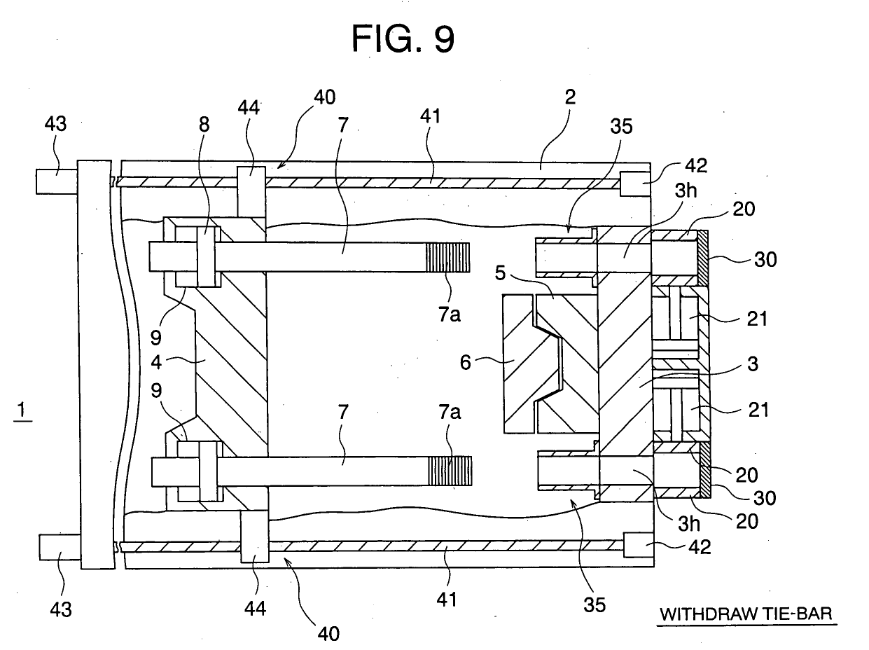

FIG. 9 is a view for explaining the method of pulling out the tie bars 7, 7 from the fixed die plate 3. In a mold clamping apparatus used for a die cast machine, exchange of dies requires that a crane etc. be used to lift the tie bars above the mold clamping apparatus. At this time, if the tie bars 7, 7 are near the dies 5, 6, the tie bars 7, 7 will interfere with the dies 5, 6 and die exchange will not be possible.

In this embodiment, the half nuts 20, 20 are released, the movement mechanisms 40, 40 are driven to retract the moveable die plate 4, and, as shown in FIG. 9, the free ends of the tie bars 7, 7 are pulled out from the through holes 3h, 3h of the fixed die plate 3 and the guide parts 35, 35. Due to this, it is possible to secure sufficient space for exchanging dies. Since it is possible to pull out the tie bars 7, 7 using the movement mechanisms 40, 40 for opening and closing the dies 5, 6, the device configuration can be simplified.

As explained above, the mold clamping apparatus 1 according to the present embodiment does not require a ring housing or rings like a toggle type mold clamping apparatus and can be reduced in size and weight. Further, in the mold clamping apparatus 1 according to the present embodiment, since the half nuts 20, 20 can be closed overlapping with the die closing operation, the cycle time of the clamping operation can be shortened. Further, in the mold clamping apparatus 1 according to the present embodiment, since the half nuts 20, 20 can be released overlapping with the unclamping operation, the cycle time of the clamping operation can be further shortened. Further, in the mold clamping apparatus 1 according to the present embodiment, since the force generated when unclamping the dies is received by the contacting members 30, 30 for positioning the tie bars 7, 7, it is possible to prevent an excessive load from being placed on the movement mechanisms 40, 40 including the screw shafts 41, 41.

### Second Embodiment

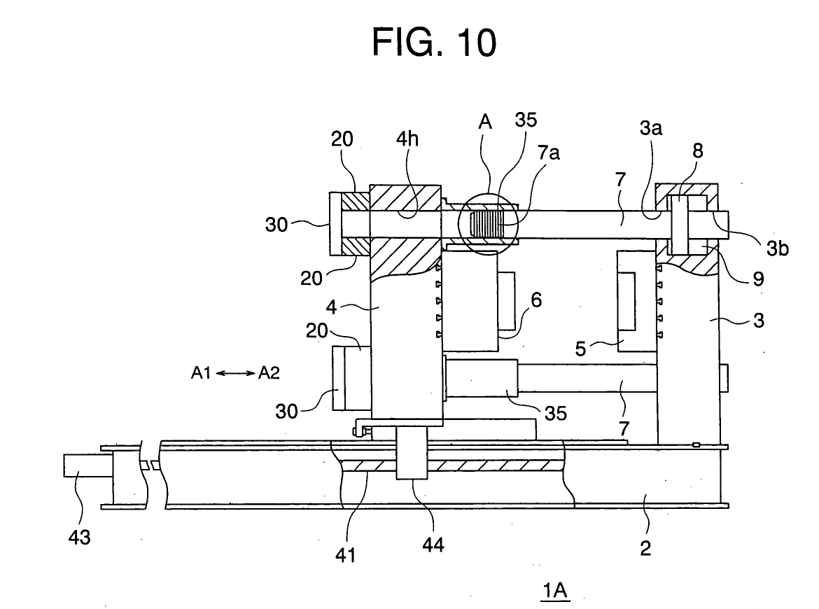

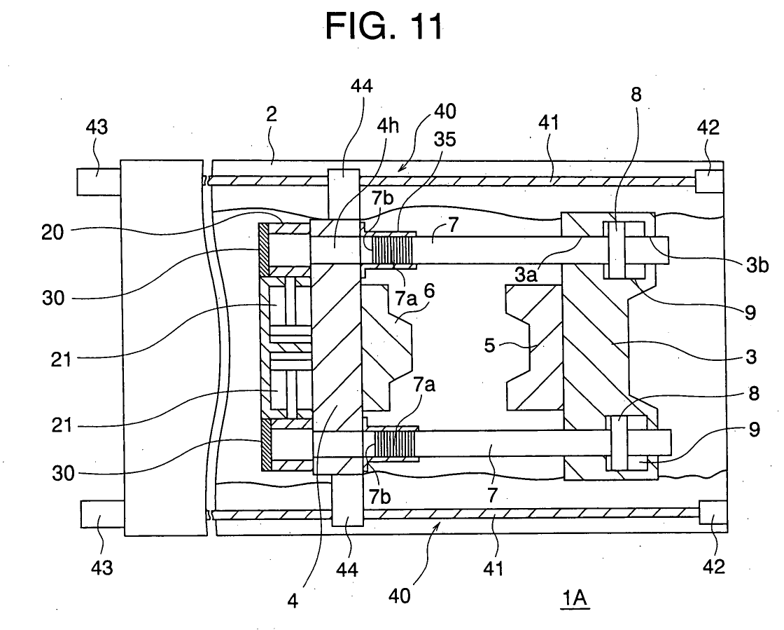

A second embodiment of the present invention will be explained next with reference to FIGS. 10 to 17. FIG. 10 is a view of the structure of a mold clamping apparatus according to the second embodiment of the present invention, while FIG. 11 is a cross-sectional view in the horizontal direction showing the structure of the mold clamping apparatus of FIG. 10. The mold clamping apparatus 1A of the second embodiment is used for a die cast machine in the same way as the first embodiment.

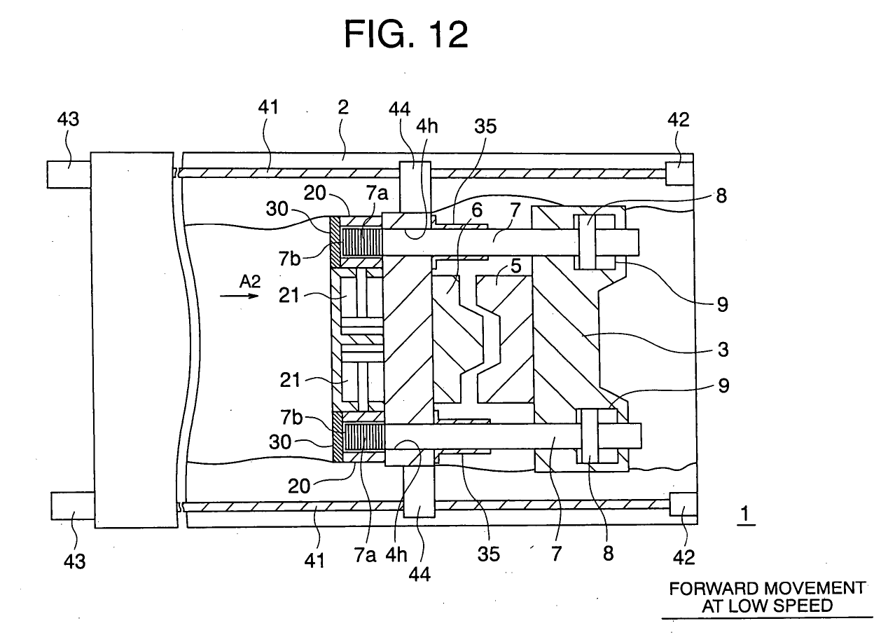

The differences between the mold clamping apparatus 1 of the first embodiment and the mold clamping apparatus 1A of the second embodiment will be explained next. In the mold clamping apparatus 1 of the first embodiment shown in FIG. 1 and FIG. 2, the pistons 8, 8 and the clamping cylinders 9, 9 are provided at the moveable die plate 4 side. As opposed to this, in the mold clamping apparatus 1A illustrated in FIG. 10 and FIG. 12, the pistons 8, 8 and the clamping cylinders 9, 9 are provided at the fixed-die plate 3 side. In this way, structurally, there is the difference that the pistons 8, 8 and the clamping cylinders 9, 9 are provided at the moveable die plate 4 side in the first embodiment and are provided at the fixed die plate 3 side in the second embodiment, but the basic configurations are similar. Further, the mold clamping apparatus 1 of the first embodiment and the mold clamping apparatus 1A of the second embodiment are the same in the operation of making the moveable die plate 4 move relative to the fixed die plate 3 through the movement mechanisms 40, 40 so as to clamp or open the fixed die 5 and the moveable die 6. Next, the mold clamping apparatus 1A of the second embodiment will be explained while focusing on the differences from the first embodiment.

As shown in FIG. 10 and FIG. 11, the mold clamping apparatus 1A of the second embodiment, like the mold clamping apparatus 1 of the first embodiment, has a fixed die plate 3, a moveable die plate 4, a pair of tie bars 7, 7, a pair of clamping cylinders 9, 9, a pair of movement mechanisms 40, 40, a pair of half nuts 20, 20, a pair of contacting members 30, 30, and a pair of guide parts 35, 35.

The moveable die plate 4 is formed with through holes 4h for insertion of the tie bars 7, 7. These through holes 4h are formed at the two top ends of the moveable die plate 4.

The tie bars 7, 7 are supported movably by the moveable die plate 4 at their first ends. The tie bars 7, 7 are supported horizontally along the opening direction A1 and the closing direction A2. The first ends of the tie bars 7, 7 are linked by pistons 8, 8. The two side parts of the pistons 8, 8 are fit into the pair of support holes 3a, 3b formed at the fixed die plate 3. The support holes 3a, 3b support the tie bars 7, 7 at the first ends. The other ends of the tie bars 7, 7, that is, the free ends, are formed with sawtooth shaped linking grooves 7a, 7a.

The clamping cylinders 9, 9 are formed inside the fixed die plate 3. The fixed die plate 3 houses pistons 8, 8 in a movable manner. The cylinder chambers of the clamping cylinders 9, 9 are supplied with high pressure working fluid, whereby force acts between the fixed die plate 3 and tie bars 7, 7 and the tie bars 7, 7 are driven relative to the fixed die plate 3. The tie bars 7, 7 can move relative to the fixed die plate 3 within the movable range of the pistons 8, 8 linked with the tie bars 7, 7, that is, the range of the strokes of the clamping cylinders 9, 9.

The configuration of the pair of movement mechanisms 40, 40 and the relationship with the moveable die plate 4 are similar to the first embodiment.

The pair of half nuts 20, 20 are arranged at the backs of the pairs of through holes 4h, 4h of the moveable die plate 4. The half nuts 20, 20 are formed with-not shown grooves engaging with the linking grooves 7a, 7a of the tie bars 7, 7. The half nuts 20, 20 are opened and closed by half nut opening/closing cylinders 21, 21. When the half nuts 20 are closed and engage with (are linked with) the linking grooves 7a, 7a of the tie bars 7, 7, the tie bars 7, 7 and moveable die plate 4 are linked together. When the half nuts 20 are opened, the link between the tie bars 7, 7 and the moveable die plate 3 is released.

The pair of contacting members 30, 30 position the tie bars 7, 7 at predetermined positions with respect to the moveable die plate 4 by being contacted against by the free ends 7b, 7b of the tie bars 7, 7. The predetermined positions are positions where the half nuts 20, 20 can link with the linking grooves 7a, 7a of the tie bars 7, 7. The tie bars 7, 7 are restricted in movement by striking the contacting members 30, 30.

The structure of a guide part 35 inside of the circle A of FIG. 10 is the same as that shown enlarged in FIG. 3.

The operation of the mold clamping apparatus of the second embodiment will be explained next with reference to FIGS. 12 to 16. The operation of the mold clamping apparatus 1A of the second embodiment is basically the same as the operation of the mold clamping apparatus 1 of the first embodiment. The state of the mold clamping apparatus 1A shown is one where the moveable die plate 4 has moved to a predetermined opening position. In this state, the pistons 8, 8 are positioned at the die side in the cylinder chambers. From this state, the servo motors 43, 43 are driven to move the moveable die plate 4 in the closing direction A2. The moveable die plate 4 is moved at a high speed from the viewpoint of shortening the cycle time. When the moveable die plate 4 moves in the closing direction A2, as shown in FIG. 12, the free ends 7b, 7b of the tie bars 7, 7 strike the contacting members 30, 30, whereby the tie bars 7, 7 stop. At this position, the linking grooves 7a, 7a of the tie bars 7, 7 can link with the half nuts 20, 20. Note that from the viewpoint of easing shock, it is preferable to reduce the operating speeds of the servo motors 43, 43 right before the free ends 7b, 7b of the tie bars 7, 7 strike the contacting members 7b, 7b.

In the state with the free ends 7b, 7b of the tie bars 7, 7 contacting against the contacting members 30, 30, the clamping cylinders 9, 9 are not supplied with high pressure working oil. Therefore, the pistons 8, 8 can move inside the cylinder chambers of the clamping cylinders 9, 9.

As shown in FIG. 12, when the free ends 7b, 7b of the tie bars 7, 7 contact against the contacting members 30, 30 and the tie bars 7, 7 are positioned, the half nut opening/closing cylinders 21, 21 are driven to close the half nuts 20, 20.

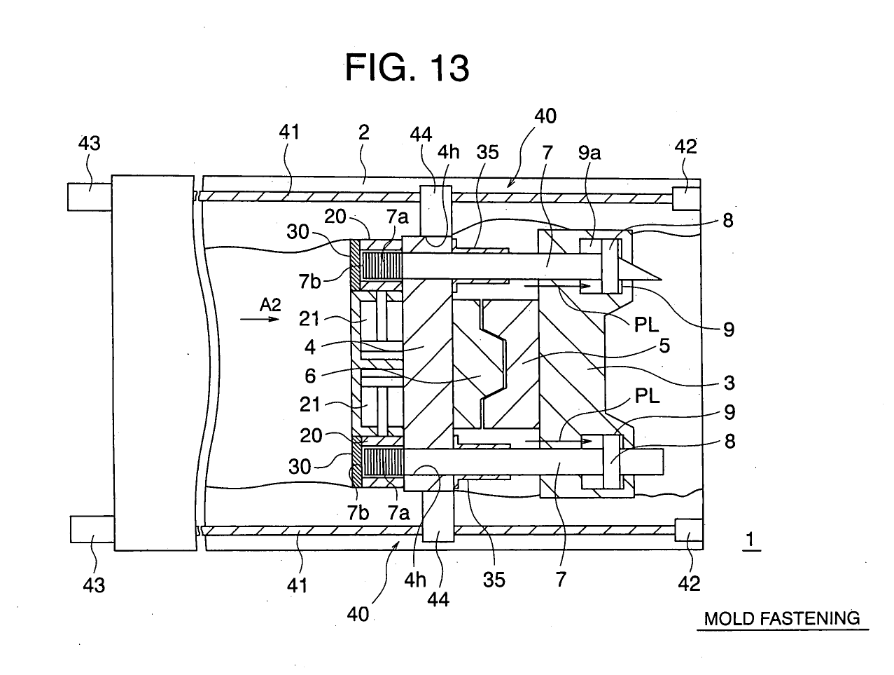

In parallel with the operation for closing the half nuts 20, 20, the moveable die plate 4 continues to be moved in the die closing direction A2 by the movement mechanisms 40, 40. The moveable die plate 4 moves to the predetermined closing position with respect to the tie bars 7, 7 and, as shown in FIG. 13, the moveable die 6 and the fixed die 5 finish being closed. That is, the moveable die plate 4 moves in the range of the strokes of the clamping cylinders 9, 9 and the dies are closed after the tie bars 7, 7 are positioned with respect to the moveable die plate 4. The pistons 8, 8 move to the opposite side from the moveable die 6 in the cylinder chambers (back side of fixed die plate 3). Due to this, the linking operations of the half nuts 20, 20 and the linking grooves 7a, 7a of the tie bars 7, 7 are performed overlappingly during movement of the moveable die plate 4.

Next, as shown in FIG. 13, the moveable die plate 4 moves to a predetermined die closing position, whereupon high pressure working oil PL is supplied to the cylinder chambers 9a, 9a of the moveable die plate 4 sides of the clamping cylinders 9, 9 and the dies are clamped. Due to the supply of the high pressure working oil PL to the cylinder chambers 9a, 9a, the pistons 8, 8 move further to the opposite side from the fixed die 5. Due to this, the tie bars 7, 7 extend and a clamping force commensurate with the amount of extension of the tie bars 7, 7 is generated. This clamping force can be controlled by adjusting the pressure of the working oil PL supplied to the cylinder chambers 9a, 9a. For example, it is possible to control the clamping force linked with the injection operation of melt into the cavity formed by the fixed die 5 and moveable die 6. Due to this, it becomes possible to cast by the minimum clamping force while preventing melt from spraying out from the joined surfaces of the moveable die 6 and fixed die 5. By making the clamping force smaller, it is possible to prevent damage to the moveable die 6 and the fixed die 5 and extend the lifetime.

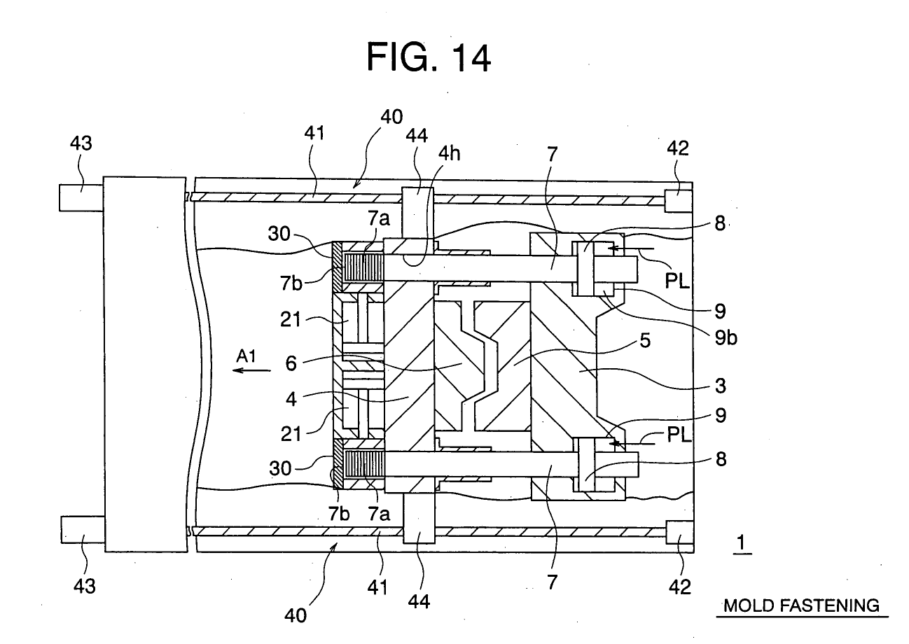

After the melt finishes being injected into and filling the cavity, as shown in FIG. 14, high pressure working oil PL is supplied to the cylinder chambers 9b, 9b at the opposite sides from the time of clamping by the clamping cylinders 9, 9. The clamping cylinders 9, 9 have a predetermined stroke, so the moveable die plate 4 moves in the opening direction within the range of that stroke, whereby the dies are unclamped. At this time, a force unclamping the dies acts on the tie bars 7, 7 is the axial direction, but the unclamping force is stopped by the contacting members 30, 30. The pistons 8, 8 move toward the die side in the cylinder chamber.

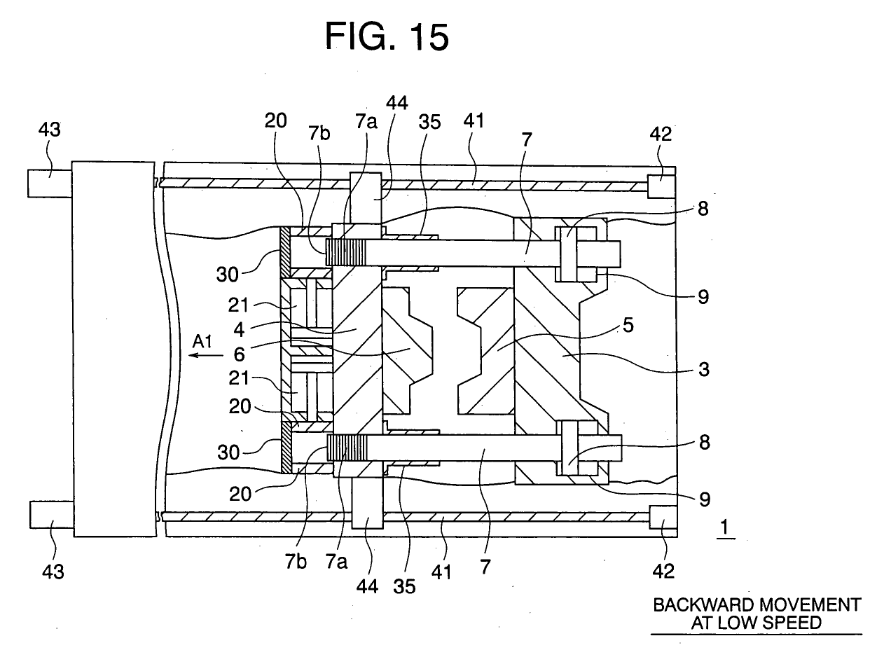

Overlapping with the unclamping action, the half nuts 20, 20 are released. Due to this, the link between the tie bars 7, 7 and the moveable die plate 4 is released. By performing the unclamping operation and the releasing operation of the half nuts 20, 20 overlappingly, the cycle time can be shortened. Next, the servo motors 43, 43 are driven and, as shown in FIG. 15, the moveable die plate 4 is retracted to a predetermined position at a low speed. The moveable die plate 4 is moved at a low speed because if the moveable die plate 4 were made to retract at a high speed rapidly right after opening the dies 5, 6, the casting product or the dies might be damaged or other problems might arise.

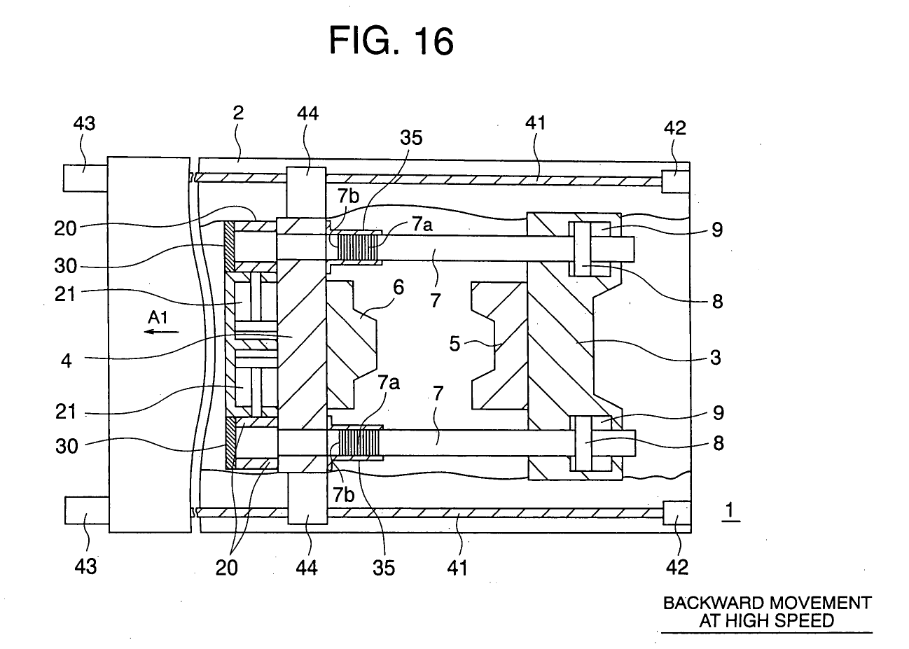

If the moveable die plate 4 is retracted to a predetermined position at a low speed, as shown in FIG. 16, the moveable die plate 4 is retracted at a high speed up to the opening position in the same way as in FIG. 10. With this operation, the series of clamping operations is ended.

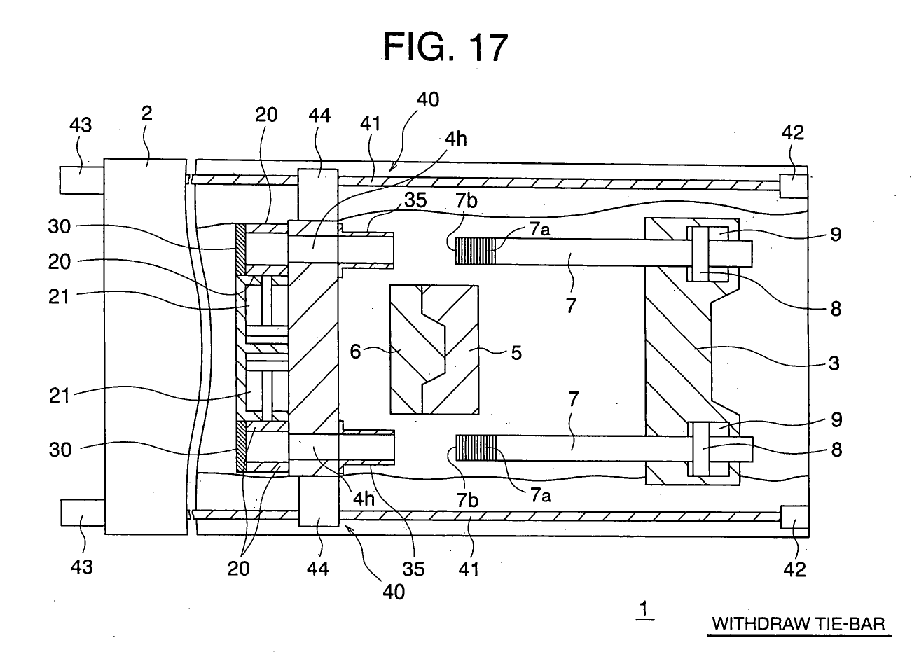

FIG. 17 is a view for explaining the method of pulling out the tie bars 7, 7 from the fixed die plate 3. In a mold clamping apparatus used for a die cast machine, exchange of dies requires that a crane etc. be used to lift the tie bars above the mold clamping apparatus. At this time, if the tie bars 7, 7 are near the fixed die 5 and the moveable die 6, the tie bars 7, 7 will interfere with the fixed die 5 and moveable die 6 and die exchange will not be possible.

In this embodiment, the half nuts 20, 20 are released, the movement mechanisms 40, 40 are driven to retract the moveable die plate 4, and the free ends of the tie bars 7, 7 are pulled out from the through holes 4h, 4h of the moveable die plate 4 and the guide parts 35, 35. Due to this, it is possible to secure sufficient space for exchanging dies. Since it is possible to pull out the tie bars 7, 7 using the movement mechanisms 40, 40 for opening and closing the fixed die 5 and the moveable die 6, the device configuration can be simplified.

As explained above, the mold clamping apparatus 1A according to the second embodiment can achieve effects similar to the mold clamping apparatus 1 of the first embodiment.

The present invention is not limited to the above embodiments. In the above embodiments, for example, the explanation was given of the case of application of the mold clamping apparatus to a die cast machine, but it may also be applied to an injection molding machine using a plastic. Further, as the movement mechanism, the case of use of screw shafts and servo motors was explained as an example, but for example it is also possible to use a cylinder apparatus or other actuator able to move the moveable die plate.

Summarizing the effects of the invention, it is possible to shorten the cycle time of the die opening and closing and the clamping operations. Further, according to the present invention, it is possible to easily pull out the tie bars.

What is claimed is:

1. A mold clamping apparatus for clamping a first die and a second die, comprising:
a fixed die plate for holding the first die and fixed to a base;
a moveable die plate for holding the second die and provided on said base so as to be able to move relative to said fixed die plate so as to clamp or open said second die with respect to said first die;
a pair of tie bars provided with linking parts at their free ends and supported by the top two ends of said moveable die plate;
a pair of clamping cylinders provided at the top two ends of said moveable die plate and driving said moveable die plate with respect to said pair of tie bars;
a pair of movement mechanisms engaged with the two bottom ends of said moveable die plate in said opening/closing directions and making said moveable die plate move when opening and closing said pair of dies;
a pair of contacting members for positioning said pair of tie bars at predetermined positions with respect to said fixed die plate by being contacted against by the free ends of said pair of tie bars; and
linking means for linking said pair of linking parts of said pair of tie bars positioned at said predetermined positions and linking said tie bars releasably at said fixed die plate.

2. A mold clamping apparatus as set forth in claim 1, wherein after the free ends of said pair of tie bars contact against said pair of contacting members and are positioned at said predetermined positions, said moveable die plate moves with respect to said pair of tie bars in the strokes of the pair of clamping cylinders, whereby the first and second dies are clamped.

3. A mold clamping apparatus as set forth in claim 2, wherein after said pair of tie bars are positioned by said pair of contacting members, said linking members are linked with said linking parts of said pair of tie bars while said closing operation is being completed.

4. A mold clamping apparatus as set forth in claim 1, wherein said first and second dies are opened from a clamped state by driving said pair of clamping cylinders in reverse from the time of the clamping operation.

5. A mold clamping apparatus as set forth in claim 4, wherein said pair of contacting members support a release force acting on said pair of tie bars due to opening of said first and second dies from said clamped state.

6. A mold clamping apparatus as set forth in claim 4, wherein an operation for opening said first and second dies from a clamped state and release of said linking means are performed overlappingly.

7. A mold clamping apparatus as set forth in claim 4, wherein after said first and second dies are opened from a clamped state, said pair of movement mechanisms are used to move said moveable die plate to open said pair of dies.

8. A mold clamping apparatus as set forth in claim 1, wherein:
pistons built into said pair of clamping cylinders are linked with the middle parts of said pair of tie bars, and
two side parts of the pistons of the tie bars are supported movably by said moveable die plate.

9. A mold clamping apparatus as set forth in claim 1, wherein said linking means are provided at the back side of said fixed die plate and are linked with linking parts of said pair of tie bars passing through said fixed die plate.

10. A mold clamping apparatus as set forth in claim 1, further comprising a pair of guide means for sealing from the outside the linking parts of said pair of tie bars and supporting said pair of tie bars movably in the range of clamping or opening said first and second dies.

11. A mold clamping apparatus as set forth in claim 1, wherein said pair of movement mechanisms pull out said pair of tie bars from said fixed die plate by making said moveable die plate retract from said fixed die plate.

12. A mold clamping apparatus for clamping a first die and a second die, comprising:
a fixed die plate for holding the first die and fixed to a base;
a moveable die plate for holding the second die and provided on said base so as to be able to move relative to said fixed die plate so as to clamp or open said second die with respect to said first die;
a pair of tie bars provided with linking parts at their free ends and supported by the top two ends of said fixed die plate;
a pair of clamping cylinders provided at the top two ends of said fixed die plate and driving said pair of tie bars with respect to said fixed die plate;
a pair of movement mechanisms engaged with the two bottom ends of said moveable die plate in said opening/closing directions and making said moveable die plate move when opening and closing said pair of dies;
a pair of contacting members for positioning said pair of tie bars at predetermined positions with respect to said moveable die plate by being contacted against by the free ends of said pair of tie bars; and
linking means for linking said pair of linking parts of said pair of tie bars positioned at said predetermined positions and linking said tie bars releasably at said moveable die plate.

13. A mold clamping apparatus as set forth in claim 12, wherein after the free ends of said pair of tie bars contact against said pair of contacting members and are positioned at said predetermined positions, said pair of tie bars move with respect to said fixed die plate in the strokes of the pair of clamping cylinders, whereby the first and second dies are clamped.

14. A mold clamping apparatus as set forth in claim 13, wherein after said pair of tie bars are positioned by said pair of contacting members, said linking members are linked with said linking parts of said pair of tie bars while said closing operation is being completed.

15. A mold clamping apparatus as set forth in claim 12, wherein said first and second dies are opened from a clamped state by driving said pair of clamping cylinders in reverse from the time of the clamping operation.

16. A mold clamping apparatus as set forth in claim 15, wherein said pair of contacting members support a release force acting on said pair of tie bars due to opening of said first and second dies from said clamped state.

17. A mold clamping apparatus as set forth in claim 15, wherein an operation for opening said first and second dies from a clamped state and release of said linking means are performed overlappingly.

18. A mold clamping apparatus as set forth in claim 15, wherein after said first and second dies are opened from a clamped state, said pair of movement mechanisms are used to move said moveable die plate to open said pair of dies.

19. A mold clamping apparatus as set forth in claim 12, wherein:
pistons built into said pair of clamping cylinders are linked with the middle parts of said pair of tie bars, and
two side parts of the pistons of the tie bars are supported movably by said fixed die plate.

20. A mold clamping apparatus as set forth in claim 12, wherein said linking means are provided at the back side of said fixed die plate and are linked with linking parts of said pair of tie bars passing through said fixed die plate.

21. A mold clamping apparatus as set forth in claim 12, further comprising a pair of guide means for sealing from the outside the linking parts of said pair of tie bars and supporting said pair of tie bars movably in the range of clamping or opening said first and second dies.

22. A mold clamping apparatus as set forth in claim 12, wherein said pair of movement mechanisms pull out said pair of tie bars from said moveable die plate by making said moveable die plate retract from said fixed die plate.
